(19) United States
(12) Patent Application Publication
(10) Pub. No.: US 2018/0262021 A1
(43) Pub. Date: Sep. 13, 2018

(54) DEVICE FOR UNIFORMLY CHARGING BATTERY PACK BY VARIABLY ADJUSTING BALANCING CURRENT USING INTERNET OF THINGS BASED ON BLUETOOTH

(71) Applicant: IBT Co., Ltd., Buk-Gu (KR)

(72) Inventors: Hoon KIM, Gwangsan-gu (KR); Yang Im AN, Gwangsan-gu (KR); Chan Ho JO, Seoul (KR); Se Hoon HONG, Ansan-Si (KR)

(21) Appl. No.: 15/907,372

(22) Filed: Feb. 28, 2018

(30) Foreign Application Priority Data
Mar. 8, 2017 (KR) 10-2017-0029493

(51) Int. Cl. H02J 7/00

(52) U.S. Cl. CPC H02J 7/0014; H02J 7/0026

(57) ABSTRACT

The present invention relates to a device for uniformly charging a battery pack, the device charging the battery pack by variably adjusting a balancing current according to a voltage difference between battery cells using an Internet of Things method based on low power Bluetooth communication. A device for uniformly charging a battery pack by variably adjusting a balancing current using Internet of Things based on a Bluetooth communication includes: a balancing part; a voltage monitoring part; an integrated controller; measuring point selecting switches; DACs; Bluetooth receiving parts transmitting a control signal received from the integrated controller to the measuring point selecting switches and the DACs by being connected thereto; and a Bluetooth transmitting part transmitting a signal for controlling the measuring point selecting switches and the DACs.

### CROSS REFERENCE TO RELATED APPLICATION

The present application claims priority to Korean Patent Application No. 10-2017-0029493, filed Mar. 8, 2017, the entire contents of which is incorporated herein for all purposes by this reference.

### BACKGROUND OF THE INVENTION

### Field of the Invention

The present invention relates generally to a device for uniformly charging a battery pack. More particularly, the present invention relates to a device for uniformly charging a battery pack by variably adjusting a balancing current according to a voltage difference between battery cells by using an Internet of Things method based on a low power Bluetooth communication.

### Description of the Related Art

Generally, as types of secondary batteries, nickel-cadmium cells, nickel-hydride cells, lithium-ion cells, lithium-ion polymer cells, etc. are provided. These secondary cells are classified into lithium based secondary cells and nickel-hydride based secondary cells

For a system requiring high power such as energy storage system (ESS) and for electrical vehicles, a plurality of battery cells that are serially connected are used by being configured in a package. A voltage difference between battery cells is generated by a chemical difference, a property difference, etc. of each battery cell constituting a battery pack. Particularly, as charging and discharging is repeated so that degradation occurs, charging and discharging times and charging and discharging amounts of each battery cell differs since a degradation degree of each cell is different. Charging and discharging times of a battery cell in which deterioration has significantly progressed is shorter than that of other cells, thus the battery cell is fully charged and fully discharged first. In addition, charging and discharging of battery cells in which degradation is relatively less are stopped before the cells are fully charged and fully discharged. When the above situation is repeated, a degradation degree of the battery cell in which deterioration has significantly progressed becomes worse, and cell voltages of the degraded battery cells decrease. Accordingly, it may cause fire or explosion of the battery pack, and thus the entire battery pack is required to be replaced due to the degradation of the battery cell unit. Accordingly, economic loss occurs.

In order to solve the above problem, battery cell balancing is applied to a battery pack. Battery cell balancing means that charging is performed while a voltage difference between battery cells that are serially connected is maintained within a predetermined range. As a conventional method of balancing battery cells, a passive cell balancing method using a resistor, and an active cell balancing method using a DC converter are widely used.

Meanwhile, FIG. 1 is a view showing a charging characteristic curve and a discharging characteristic curve of a lithium iron phosphate battery. As charging is progresses, when a battery is charged to 10% capacity, an output voltage of the battery rises up to 3.2V (herein, referred as ‘low voltage rising section’), and when the battery is charged to 85% capacity, and output of voltage of the battery rises 0.2V˜3.4V (herein, referred as ‘uniform voltage section’). Then, in order to charge the remaining 15% capacity, the output voltage rapidly rises up to 3.9V (herein, referred as ‘high voltage rising section’). In other words, the lithium iron phosphate battery is fully charged by passing a low voltage rising section, a uniform voltage section, and a high voltage rising section.

A conventional passive cell balancing method senses a cell voltage in real time, and when a maximum cell voltage is equal to or greater than a balancing voltage (generally, 3.7V), voltage balancing with other voltage cells is performed by discharging the cell voltage of the corresponding battery cell by using a discharging resistor having a predetermined size. However, when the balancing voltage belongs to a high voltage rising section or a voltage difference between a maximum voltage and a minimum voltage is large, and an amount of balancing current is very small compared with an amount of charging current, a voltage that is charged by the charging current is larger than a voltage that is discharged by the balancing current even though balancing is performed by reducing the cell voltage by discharging the battery cell using the balancing current. Accordingly, the voltage of the battery cell continues rising.

The foregoing is intended merely to aid in the understanding of the background of the present invention, and is not intended to mean that the present invention falls within the purview of the related art that is already known to those skilled in the art.

### Documents of Related Art

(Patent Document 1) PCT Patent Application Publication No. WO2012/124845;

(Patent Document 2) Japanese Patent Application No. 2008-233966; and

(Patent Document 3) Japanese Patent Application No. 2003-413965.

### SUMMARY OF THE INVENTION

Accordingly, the present invention has been made keeping in mind the above problems occurring in the related art, and the present invention is intended to provide a device for uniformly charging a battery pack by using an Internet of Things method based on a Bluetooth communication, the device being capable of improving cell balancing efficiency by performing Bluetooth communication between each battery cell and an integrated controller, adjusting an amount of a balancing current by using a balancing transistor based on whether or not the battery pack in which battery cells are serially connected enters into a high voltage rising section, and a voltage difference between a maximum cell voltage and a minimum cell voltage, and performing cell balancing in association with a charging current.

In addition, another object of the present invention is to provide a device for uniformly charging a battery pack by using an Internet of Things method based on a Bluetooth communication, the device being capable of determining whether or not a failure has occurred in a balancing transistor by performing Bluetooth communication between each battery cell and an integrated controller, and sensing a collector voltage of the balancing transistor while controlling an amount of a balancing current.

In order to achieve the above object, according to one aspect of the present invention, there is provided a device for uniformly charging a battery pack by variably adjusting a balancing current using Internet of Things based on a Bluetooth communication, wherein the device includes a plurality of serially connected battery cells, the device including: a balancing part including balancing resistors and balancing transistors, each of the resistors and the balancing transistors being connected to each battery cell in parallel; a voltage monitoring part measuring cell voltages of the battery cells or collector voltages of the balancing transistors; an integrated controller determining a balancing target battery cell and an amount of the balancing current by receiving as input the cell voltages measured by the voltage monitoring part, controlling a base current of the balancing transistor connected to the balancing target battery cell according to the determined amount of the balancing current, and determining whether or not a failure has occurred in the balancing transistor by measuring the collector voltage of the balancing transistor while controlling the base current; measuring point selecting switches, each of the switches being controlled by the integrated controller to selectively control so that the voltage sensed by the voltage monitoring part to be the voltage of each battery cell or to be the collector voltage of each balancing transistor; digital-to-analog converters (DAC), each of the DACs controlling the base current of each balancing transistor by being controlled by the integrated controller; Bluetooth receiving parts, each of the Bluetooth receiving parts being connected to an associated measuring point selecting switch and an associated DAC, and transmitting a control signal received from the integrated controller to the measuring point selecting switch and the DAC; and a Bluetooth transmitting part provided in the integrated controller, the Bluetooth transmitting part transmitting a signal for controlling the measuring point selecting switches and the DACs.

According to the present invention described as above, a charging current is reduced by performing cell balancing in association with a battery charger, and balancing efficiency is maximized since an amount of a balancing current is adjusted by adjusting a base current of a balancing transistor according to whether or not a maximum cell voltage has entered into a high voltage rising section and a voltage difference between the maximum cell voltage and a minimum cell voltage.

In addition, whether or not a failure has occurred in the balancing transistor can be determined by measuring a collector voltage of the balancing transistor while controlling an amount of a balancing current.

In addition, a circuit configuration becomes simple since the battery pack and the integrated controller communicate through Bluetooth based wireless communication, and the 5 manageability of a manager can be improved since the integrated controller transmits to the manager a beacon signal related to the battery pack.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view showing a charging characteristic and a discharging characteristic of a lithium iron phosphate battery.

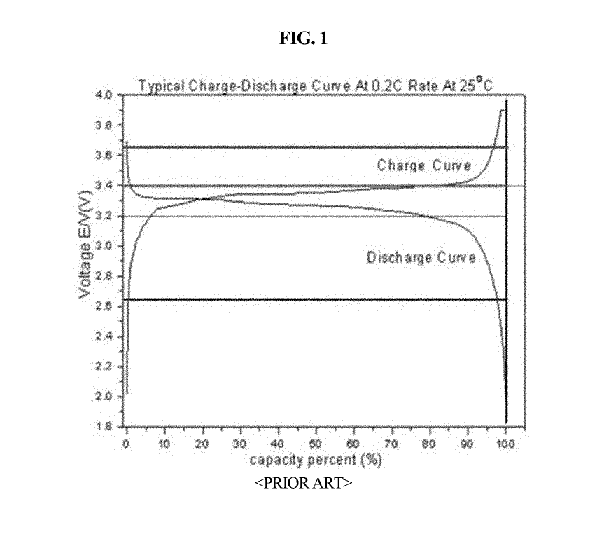

FIG. 2 is a block diagram showing a configuration of a battery charging system including a battery balancing device according to the present invention.

FIG. 3 is a view showing an operational flowchart of an integrated controller according to the present invention.

### DETAILED DESCRIPTION OF THE INVENTION

Hereinbelow, a device for uniformly charging a battery pack variably adjusting a balancing using an Internet of Things method based on a Bluetooth communication will be described in detail with reference to the accompanying drawings.

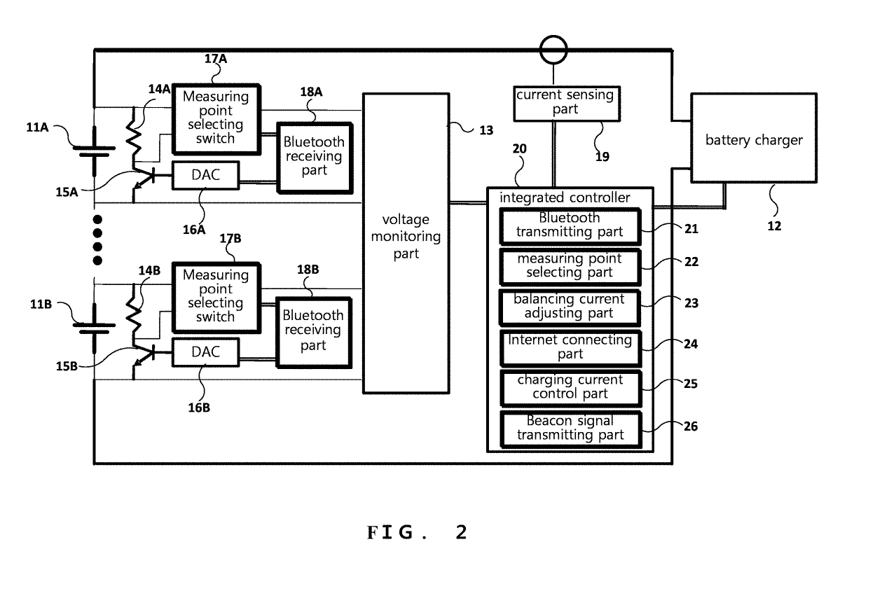

FIG. 2 is a block diagram showing a configuration of a battery charging system including a battery balancing device according to the present invention.

A battery charging system according to the present invention includes: a battery charger 12 supplying a charging current to a plurality of serially connected battery cells 11A and 11B; a voltage monitoring part 13 measuring cell voltages of the battery cells; a balancing part configured with balancing resistors 14A and 14B and balancing transistors 15A and 15B, the resistors and the transistors being respectively connected to the battery cells 11A and 11B in parallel; an integrated controller 20 determining a balancing target battery cell by receiving as input the cell voltages measured by the voltage monitoring part 13, and determining whether or not to perform balancing, and performing balancing by controlling the balancing part; digital-to-analog converters (DAC) 16A and 16B respectively adjusting a base current of the balancing transistors 15A and 15B by being controlled by the integrated controller 20 so that balancing is performed; measuring point selecting switches 17A and 17B connected to the voltage monitoring part 13 by respectively selecting one of a common contact between the battery cell and the balancing resistor or a common contact between the balancing resistor and the balancing transistor; Bluetooth receiving parts 18A and 18B respectively receiving Bluetooth signals from the integrated controller 20, and respectively transmitting the received singles to the DAC 16A and 16B and the measuring point selecting switches 17A and 17B; and a current sensing part 19 detecting an amount of the charging current supplied from the battery charger 12 to the plurality of battery cells.

The integrated controller 20 includes a Bluetooth transmitting part 21 transmitting a Bluetooth signal to Bluetooth receiving parts 18A and 18B provided in a battery side, a measuring point selection part 22 controlling the measuring point selecting switches 17A and 17B through the Bluetooth receiving parts 18A and 18B and the Bluetooth transmitting part 21, a balancing current adjusting part 23 outputting a balancing control signal for adjusting the base current of the balancing transistor 15A or 15B connected to a balancing target battery cell through the Bluetooth receiving parts 18A or 18B and the Bluetooth transmitting part 21, a charging current control part 25 for decreasing the charging current supplied from the battery charger 12 to the plurality of battery cells when performing balancing for the balancing target battery cell, a beacon signal transmitting part 26 outputting an identifier and status information of the battery pack to an external intelligent mobile terminal, and an Internet connecting part 24 outputting the identifier and the status information of the battery pack to an external management server.

A beacon is a signal generating device that is used in Internet of Things based on Bluetooth, and transmits a unique identifier ID thereof using low power. A mobile intelligent terminal (smart-phones, tablet PCs, etc.) integrating a Bluetooth protocol using module may receive and check the unique identifier transmitted from the beacon and may specify the beacon transmitting the corresponding signal. The integrated controller of the present invention may transmit unique identifier information and status information of the battery pack to a management sever through Internet, and also transmit to a mobile intelligent terminal of a manager who manages the corresponding battery pack by using a beacon signal.

Operations of the battery charging system and the battery balancing device which are configured as above will be described.

The battery charger 12 supplies a charging current to the plurality of serially connected battery cells 11A and 11B, and the plurality of battery cells 11A and 11B is charged by the charging current. The voltage monitoring part 13 measures a charging voltage of each battery cell, and provides cell voltage information detected from each battery cell to the integrated controller 20.

The integrated controller 20 determines whether or not to perform balancing based on the cell voltage information of the battery cells, determines a balancing target battery cell and an amount of a balancing current, and performs balancing for the balancing target battery cell based on the amount of the balancing current. The amount of the balancing current is determined based on whether or not a maximum cell voltage has entered into a high voltage rising section, and a voltage difference between the maximum cell voltage and a minimum cell voltage.

The integrated controller 20 determines whether or not to perform balancing based on the cell voltage information of the battery cells, and determines a balancing target battery cell and an amount of a balancing current. When balancing target battery cell is determined, the charging current control part 25 of the integrated controller 20 outputs a signal to the battery charger 12 so that the charging current supplied from the battery charger 12 to the plurality of battery cells 11A and 11B is decreased.

At the same time, the balancing current adjusting part 23 of the integrated controller 20 adjusts a balancing current of a balancing target battery cell (for example, assuming that balancing target battery cell is a first battery cell 11A). Describing in detail a process of adjusting the balancing current of the first battery cell 11A, the balancing current adjusting part 23 of the integrated controller 20 determines the amount of the balancing current of the balancing target battery cell, and outputs a balancing control signal according to the determined amount of the balancing current through the Bluetooth transmitting part 21. Then, the balancing control signal is received by the Bluetooth receiving part 18A in association with the balancing target battery, and the DAC 16A converts the balancing control signal to an analog signal and outputs the converted analog signal to the balancing transistor 15A. Accordingly, the amount of the balancing current passing the balancing resistor 14A is adjusted according to a base current of the balancing transistor 15A, and a discharging speed of the charging voltage of the battery cell changes according to the amount of the balancing current.

Meanwhile, the measuring point selecting part 22 of the integrated controller 20 controls the measuring point selecting switch 17A to select the common contact between the battery cell 11A and the balancing resistor 14A through communication between the Bluetooth transmitting part 21 and the Bluetooth receiving part 18A when measuring a battery cell voltage, and controls the measuring point selecting switch 17A to select the common contact between the balancing resistor 14A and the balancing transistor 15A when determining whether or not a failure has occurred in the balancing part.

When the measuring point selecting switch 17A selects the common contact between the balancing resistor 14A and the balancing transistor 15A, the voltage monitoring part 13 may measure a collector voltage of the balancing transistor 15A. When determining whether or not a failure has occurred in the balancing part, the voltage monitoring part 13 measures the collector voltage of the balancing transistor 15A. The integrated controller 20 controls the base current of the balancing transistor 15A so that the amount of the balancing current becomes a maximum value, and determines that a wire disconnection failure has occurred in the balancing transistor 15A when the collector voltage does not decrease by measuring the collector voltage of the balancing transistor 15A. In addition, the integrated controller 20 controls the base current of the balancing transistor 15A so that the amount of the balancing current becomes a median value, and determines that a short failure has occurred in the balancing transistor 15A when the collector voltage is zero by measuring the collector voltage of the balancing transistor 15A.

When balancing of an arbitrary battery cell is performed or a failure of the balancing part is detected, the beacon signal transmitting part 26 outputs a beacon signal including unique identifier information and status information of the corresponding battery cell based on a Bluetooth protocol. The beacon signal is output to the mobile intelligent terminal of the manager who manages the battery pack so that the manager may easily recognize the status of the corresponding battery pack. In addition, the integrated controller 20 transmits the unique identifier information and the status information of the corresponding battery pack to the external management server through the Internet connecting part 24.

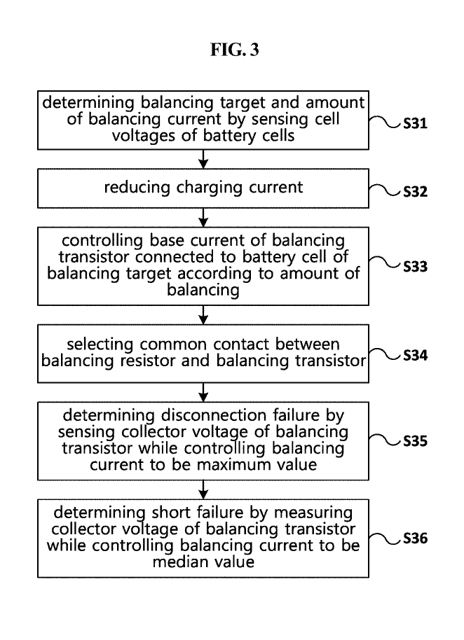

FIG. 3 is a view showing an operational flowchart of an integrated controller according to the present invention.

In step S31, the integrated controller 20 measures a cell voltage of each battery cell by using the voltage monitoring part 13, and determines a balancing target battery cell and an amount of a balancing current. Herein, the amount of the balancing current is determined based on whether or not a maximum cell voltage has entered into a high voltage rising section, and a voltage difference between the maximum cell voltage and a minimum cell voltage. When the voltage difference becomes large, the amount of the balancing current increases, when the voltage difference becomes small, the amount of the balancing current decreases, and when the maximum cell voltage has entered into a high voltage rising section, the amount of the balancing current increases.

In step S32, the charging current adjusting part 25 of the integrated controller 20 controls the charging current supplied from the battery charger 12 to the plurality of the battery cells 11A and 11B to be decreased when balancing is performed.

In step S33, the balancing current adjusting part 23 of the integrated controller 20 adjusts a base current of the balancing transistor connected to the balancing target battery cell according to the amount of the balancing current determined in step S31. Herein, wireless communication is used between the Bluetooth transmitting part 21 and the Bluetooth receiving part in association of the corresponding balancing target battery cell. The amount of the balancing current passing the balancing resistor is determined according to the base current of the balancing transistor, and a discharging speed of the corresponding balancing target battery cell is determined based thereon. According to the present invention, when a voltage difference between a maximum cell voltage and a minimum cell voltage is large, or when the maximum cell voltage has entered into a high voltage rising section, a cell discharging speed is increased by increasing an amount of a balancing current, thus cell balancing is performed quickly.

In addition, the integrated controller 20 determines periodically or when necessary whether or not a failure has occurred in the balancing transistor. In step S34, the measuring point selecting part 22 of the integrated controller 20 controls the measuring point selecting switch connected to a target battery cell in which a failure thereof is to be detected to select a common contact between the balancing resistor and the balancing transistor such that voltage monitoring part measures a collector voltage of the balancing transistor. In step S35, the integrated controller 20 measures the collector voltage of the balancing transistor while controlling the base current of the balancing transistor so that the amount of the balancing current becomes a maximum value, and when the collector voltage does not decrease, the integrated controller 20 determines that a disconnection failure has occurred in the balancing transistor. In addition, in step S36, the integrated controller 20 measures the collector voltage of the balancing transistor while controlling the base current of the balancing transistor so that the amount of the balancing current becomes a median value, and when the collector voltage is zero, the integrated controller 20 determines that a short failure has occurred in the balancing transistor.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A device for uniformly charging a battery pack by variably adjusting a balancing current using Internet of Things based on a Bluetooth communication, wherein the device includes a plurality of serially connected battery cells, the device comprising:
a balancing part including balancing resistors and balancing transistors, each of the resistors and the balancing transistors being connected to each battery cell in parallel;
a voltage monitoring part measuring cell voltages of the battery cells or collector voltages of the balancing transistors;
an integrated controller determining a balancing target battery cell and an amount of the balancing current by receiving as input the cell voltages measured by the voltage monitoring part, controlling a base current of the balancing transistor connected to the balancing target battery cell according to the determined amount of the balancing current, and determining whether or not a failure has occurred in the balancing transistor by measuring the collector voltage of the balancing transistor while controlling the base current;
measuring point selecting switches, each of the switches being controlled by the integrated controller to selectively control so that the voltage sensed by the voltage monitoring part to be the voltage of each battery cell or to be the collector voltage of each balancing transistor;
digital-to-analog converters (DAC), each of the DACs controlling the base current of each balancing transistor by converting a balancing control signal transmitted from the integrated controller to an analog signal so that the amount of the balancing current becomes a maximum or median value;
Bluetooth receiving parts, each of the Bluetooth receiving parts being connected to an associated measuring point selecting switch and an associated DAC, and transmitting the balancing control signal received from the integrated controller to the measuring point selecting switch and the DAC; and
a Bluetooth transmitting part provided in the integrated controller, the Bluetooth transmitting part transmitting a signal for controlling the measuring point selecting switches and the DACs, wherein
the integrated controller measures the collector voltage of each balancing transistor while controlling the base current of each balancing transistor so that the amount of the balancing current becomes a maximum value, and determines that a disconnection failure has occurred in each balancing transistor when the collector voltage does not decrease, and the integrated controller measures the collector voltage of each balancing transistor while controlling the base current of each balancing transistor so that the amount of the balancing current becomes a median value, and determines that a short failure has occurred in each balancing transistor when the collector voltage is zero.

2. The device of claim 1, further comprising a battery charger supplying a charging current to the plurality of battery cells, wherein the integrated controller further includes a charging current control unit controlling the charging current output from the battery charger to decrease.

3. The device of claim 2, further comprising a current sensing part sensing a size of the charging current supplied from the battery charger to the plurality of battery cells.

4. The device of claim 1, wherein the integrated controller further includes a beacon signal transmitting part outputting a beacon signal including unique identifier information and status information of the battery pack, the beacon signal being based on a Bluetooth protocol.
